(19) United States
(12) Patent Application Publication
(10) Pub. No.: US 2019/0087521 A1
(43) Pub. Date: Mar. 21, 2019

(54) STOCHASTIC DATAFLOW ANALYSIS FOR PROCESSING SYSTEMS

(71) Applicant: QUALCOMM Incorporated, San Diego, CA (US)

(72) Inventor: John Haskins, Jr., Wake Forest, NC (US)

(21) Appl. No.: 15/712,106

(22) Filed: Sep. 21, 2017

(51) Int. Cl. G06F 17/50

(52) U.S. Cl. CPC G06F 17/5022; G06F 2217/68

(57) ABSTRACT

Techniques for stochastic modeling of a processing system include tracking relationships between producer instructions and consumer instructions of an instruction set in a matrix. Rows of the matrix include one or more producer instructions and columns of the matrix include one or more consumer instructions. An element of the matrix at an intersection of a row and a column represents a relationship between at least one producer instruction associated with the row and at least one consumer instruction associated with the column. A counter at the element tracks the numbers of instances of the relationship encountered between the at least one producer instruction and the at least one consumer instruction. Design and architecture of the processor are based on the values of the counters at the elements of the matrix.

### FIELD OF DISCLOSURE

Disclosed aspects are directed to analysis and design of processing systems. More specifically, exemplary aspects are directed to mechanisms for stochastic dataflow analysis, e.g., with respect to producer-consumer relationships between pairs of instructions.

### BACKGROUND

With advances in processing systems, there is an ever increasing need for improving processing speeds and performance of instruction processing. Intelligent design of the processor architecture, execution pipelines, etc., which take into account dataflow patterns can contribute to achieving the above objectives of speed and performance For this, an efficient and detailed analysis of the movement of data through the various stages of instruction processing is important but also challenging because of the vast design space. Modern processors employ hundreds or even thousands of instructions of various flavors, whose sequencing and execution may not have a deterministic or predictable order in many instances. These hurdles are further exacerbated by changes in control flow which may be caused by branching, conditional execution, etc.

Accordingly, there is a need for efficient dataflow analysis in the design of processing systems.

### SUMMARY

Exemplary aspects of the invention are directed to stochastic modeling of a processing system. Relationships between producer instructions and consumer instructions of an instruction set are tracked using a matrix. Rows of the matrix include producer instructions and columns of the matrix include consumer instructions. An element of the matrix at an intersection of a row and a column represents a relationship between a producer instruction associated with the row and a consumer instruction associated with the column. A counter disposed at the element tracks the numbers of instances of the relationship encountered between the producer instruction and the consumer instruction. Design and architecture of the processor may be based on the values of the counters at the elements of the matrix.

In some aspects, the above-described techniques may be applied to reconfigurable processors (e.g., field-programmable gate array (FPGA) implementations) wherein runtime data pertaining to relationships between producer and consumer instructions may be used in stochastic modeling or statistical profiling of instructions being executed, and processor architectures may be appropriately configured/reconfigured.

Accordingly, an exemplary aspect is directed to a method of modeling a processing system, the method comprising tracking relationships between one or more producer instructions and one or more consumer instructions, the producer instructions and consumer instructions belonging to an instruction set executable by a processor, determining a number of instances of one or more of the relationships tracked, and determining improvements in a design of the processor based on the number of instances of the one or more relationships tracked.

Another exemplary aspect is directed to an apparatus comprising a processor, logic configured to track relationships between one or more producer instructions and one or more consumer instructions, the producer instructions and consumer instructions belonging to an instruction set executable by the processor, logic configured to determine a number of instances of one or more of the relationships tracked, and logic configured to determine improvements in a design of the processor based on the number of instances of the one or more relationships tracked.

Another exemplary aspect is directed to a non-transitory computer-readable storage medium comprising code, which, when executed by a computer, causes the computer to perform operations for modeling a processor. The non-transitory computer-readable storage medium comprises code for tracking relationships between one or more producer instructions and one or more consumer instructions, the producer instructions and consumer instructions belonging to an instruction set executable by the processor, code for determining a number of instances of one or more of the relationships tracked, and code for determining improvements in a design of the processor based on the number of instances of the one or more relationships tracked.

Another exemplary aspect is directed to an apparatus comprising means for processing, means for tracking relationships between one or more producer instructions and one or more consumer instructions, the producer instructions and consumer instructions belonging to an instruction set executable by the means for processing, means for determining a number of instances of one or more of the relationships tracked, and means for determining improvements in a design of the processor based on the number of instances of the one or more relationships tracked.

### BRIEF DESCRIPTION OF THE DRAWINGS

The accompanying drawings are presented to aid in the description of aspects of the invention and are provided solely for illustration of the aspects and not limitation thereof.

FIG. 1 depicts an exemplary processing system according to aspects of this disclosure.

FIGS. 2A-B illustrate aspects of tracking producer-consumer relationships between instructions, according to aspects of this disclosure.

FIG. 3 depicts an exemplary method for modeling a processing system according to aspects of this disclosure.

FIG. 4 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs), field-programmable gate arrays (FPGAs), etc.), by program instructions being executed by one or more processors, or by a combination of both. Additionally, these sequences of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Aspects of this disclosure are directed to exemplary mechanisms for stochastic dataflow analysis, useful in the design and architecture of processing systems. More specifically, in some aspects, producer-consumer relationships are tracked between groups of instructions. Suitable combinations of hardware and software techniques are also disclosed for the above-mentioned tracking, including, for example, matrices with elements thereof comprising counters. The counters may be disposed at the elements and configured to track respective producer-consumer relationships. The matrices may be stored on chip (e.g., configured as a component of a central processing unit (CPU)) and information from the counters may be used to selectively improve speed and performance of the instruction groups associated with counters having high count values. Viewed another way, popular or more frequently encountered instruction groups are recognized and processing of those instruction groups may be improved, e.g., through design and architecture adjustments.

As previously mentioned, the exemplary techniques may be used in reconfigurable processors (e.g., field-programmable gate array (FPGA) implementations) wherein runtime data pertaining to relationships between producer and consumer instructions may be used in stochastic modeling or statistical profiling of instructions being executed, and processor architectures may be appropriately configured/reconfigured.

In addition to the above tracking mechanisms, related methods for managing the tracking mechanisms are also disclosed. For instance, instructions are disclosed which may be used to perform operations on the matrices, such as resetting the matrix, retrieving data from a matrix, inserting data into the matrix, etc. These and related aspects of this disclosure will now be explained in greater detail with reference to the figures.

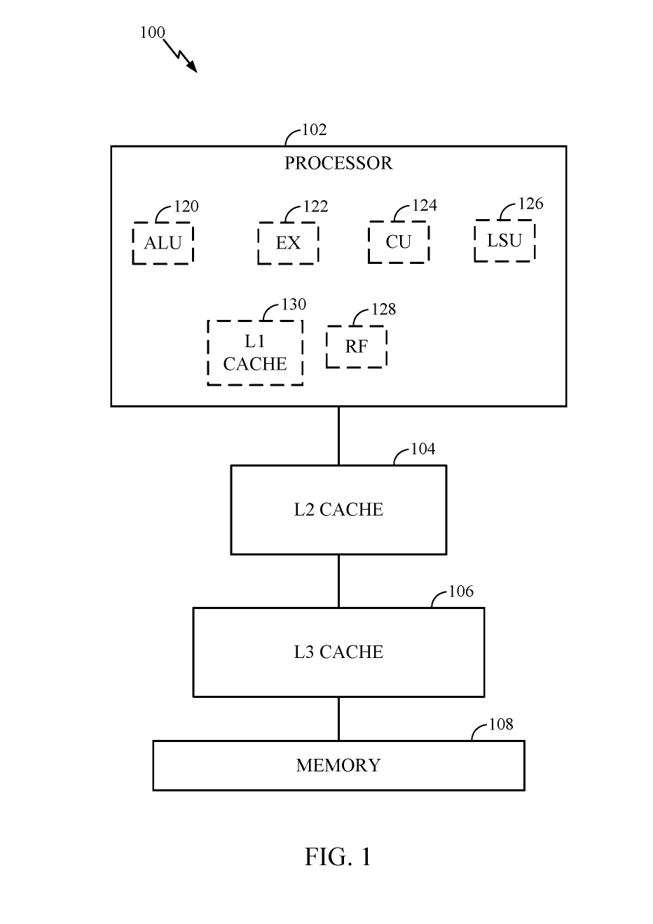

With reference first to FIG. 1, processing system 100 is illustrated, wherein processing system 100 may be configured according to exemplary aspects of this disclosure. As shown, processing system 100 includes processor 102, two levels of backing caches shown as L2 cache 104 and L3 cache 106, and memory 108 (e.g., a main memory). Although not shown, there may be other processors or cores also present in processing system 100 which may share the above-mentioned caches and memory structures. Processor 102 may support, without limitation, multithreaded processing, parallel processing, superscalar processing, vector processing (e.g., single instruction multiple data (SIMD)), scalar processing, etc. Furthermore, processor 102 may be configured as any processing core such as a microprocessor, central processing unit (CPU), a digital signal processor (DSP), a general purpose processor, etc.

In exemplary aspects, processor 102 may be configured to implement a pipelined operation in an instruction pipeline (not explicitly shown) with pipeline stages such as instruction fetch, decode, execute, memory access, and write back. Instructions may be fetched and dispatched to one or more functional blocks such as arithmetic and logical unit (ALU) 120, execution unit (EX) 122, control unit (CU) 124, load/store unit (LSU) 126, etc. These functional blocks may process instructions and data in one or more pipeline stages. The functional blocks may retrieve operands related to instruction processing from register file (RF) 128 and update RF 128 at the write back or commit stage of the instruction pipeline. Processor 102 may include L1 cache 130, which may be a fast, small-sized on-chip cache located on a same chip as processor 102.

Among instructions of any program or application which are executed by processor 102 there may be relationships between two or more instructions. One such relationship is termed as a producer-consumer relationship, wherein the output or production (e.g., a register) of a first instruction (referred to as a producer instruction) may be an input to a second instruction (referred to as a consumer instruction). It will be understood that the first and second instructions need not be separate instructions because the same instruction may also produce a value which may be consumed, to update the same register value (e.g., in the case of an instruction for incrementing a register by a constant value). On the other hand, the producer-consumer relationships may also extend between two or more instructions and need not be limited to two instructions, e.g., in the case where the production of the producer instruction may be consumed by two or more instructions. In these and various other types of instruction dependencies which are known in the art, it is seen that the dependencies or relationships between instructions may be exploited to improve the performance of instruction processing.

For instance, if a producer-consumer relationship is considered wherein the producer is an ADD instruction, whose production or output (say a first register) is utilized as an input for one or more consumer instructions such as a LOAD, STORE, or SHIFT instruction, then by tracking the number of instances that such a relationship is encountered during instruction processing of an instruction sequence being executed by processor 102, some improvements may be made to the design of processor 102. Accordingly, if it is recognized that the output of the ADD instruction is consumed by LOAD/STORE instructions a relatively high number of times, then ALU 120 (in which the ADD instruction may be executed) may be placed close to load/store unit (LSU) 126 configured to handle the LOAD/STORE instructions. Alternatively, a forwarding path may be provided between these two units ALU 120 and LSU 126. Numerous other adjustments may be made to the design of processor 102 based on such relationships being tracked. Similarly, if the output of the ADD instruction is used a relatively high number of times by a consumer SHIFT instruction, and assuming the SHIFT instruction is executed by the execution unit (EU) 122, the placement and routing decisions between ALU 120 and EU 122 may be made accordingly.

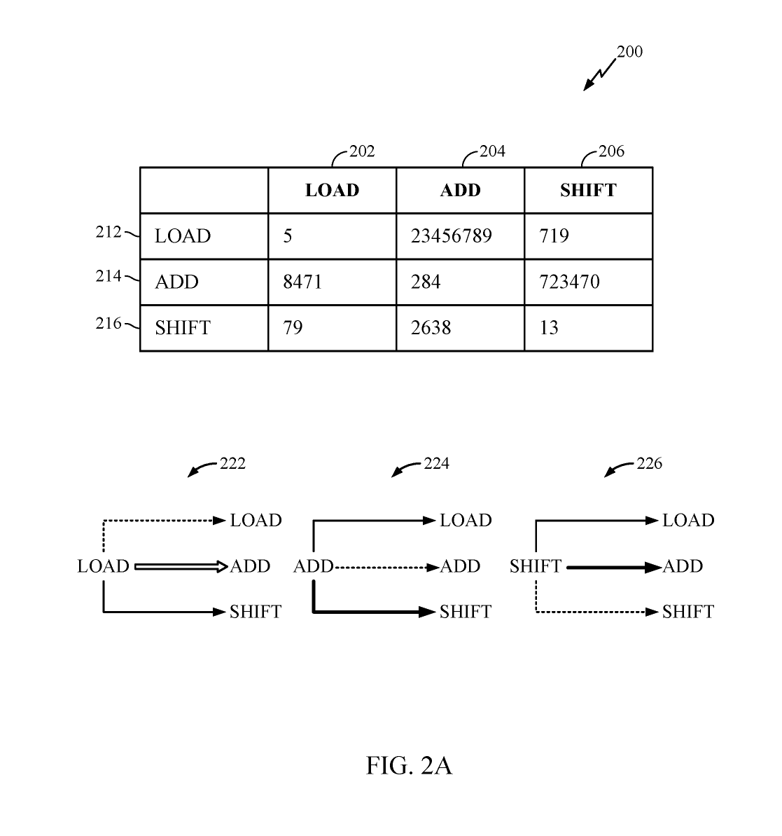

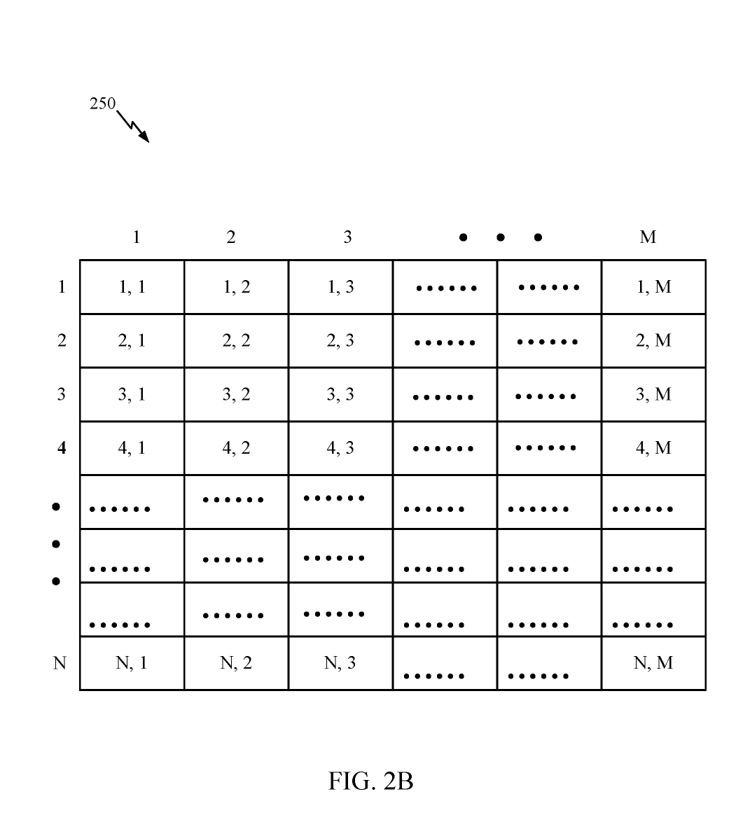

The above concept of tracking relationships is illustrated in FIG. 2A in the format of table 200. Three instructions, LOAD, ADD, and SHIFT are shown in columns 202, 204, and 206, respectively and also in rows 212, 214, and 216, respectively. At the intersection of each of the rows 212, 214, 216 and columns 202, 204, 206, the elements of table 200 indicate the number of times that an instruction in the corresponding row was a producer of the instruction in the corresponding column.

For instance, relationship 222 pertains to LOAD instruction in row 212 being a producer of instructions in columns 202, 204, and 206 comprising the respective LOAD, ADD, and SHIFT instructions. As shown, there is a high instance of the LOAD instruction being a producer of values consumed by the ADD instruction in column 204, which may motivate a design choice of placing LSU 126 close to ALU 120, as noted above. Relationship 224 similarly pertains to ADD instruction in row 214 being a producer of instructions in columns 202, 204, and 206 comprising the respective LOAD, ADD, and SHIFT instructions; and relationship 226 similarly pertains to SHIFT instruction in row 216 being a producer of instructions in columns 202, 204, and 206 comprising the respective LOAD, ADD, and SHIFT instructions. These relationships and corresponding numbers of instances of these relationships (elements of table 200) may be used to rank or order the relationships or estimate probabilities of these relationships being formed. A statistical analysis may be performed on the number of instances which may be used in stochastic modeling, with a view to accelerating or improving performance of the most common cases or highest numbers of instances. Such an approach may be considered as an extension of Amdahl's law (which, as will be recognized by persons skilled in the art, provides a formulaic approach for determining particular parts of or subsets of a system, whose improvements may lead to the maximum possible improvement of the system as a whole).

With the above principles in mind, FIG. 2B is considered, wherein a more generalized version of FIG. 2A is illustrated. FIG. 2B shows an N×M matrix 250 with N rows designated with the reference numerals 1-N, and M columns also designated with the reference numerals 1-M. At the intersection of each row and column, elements of the N×M matrix 250 are designated with reference numerals in the format of “row number, column number”.

In an exemplary aspect, processor 102 may have an instruction set with N×M matrix 250 representing a set of possible producer-consumer relationships for the instruction set. Without loss of generality, each of the N rows may represent instructions in a producer role while the columns may represent instructions in a consumer role. In one example, N and M may be the same or equal, and thus, N×M matrix 250 may track relationships between each instruction of the N×M matrix 250 in a producer role and each instruction of the N×M matrix 250 in a consumer role. However, it may also be possible for two or more instructions to produce results which are consumed by the same instruction, or for one instruction to produce results which are consumed by two or more instructions. To accommodate these variations, the values of N and M may be selected based on the specific types of producer-consumer relationships between one or more instructions in a producer role and one or more instructions in a consumer role, without loss of generality. In alternative implementations, if there are more than one producer instructions mapping to one consumer instruction, then corresponding counters for the more than one producers may be incremented; or similarly, for a one-to-many mapping between producer instructions and consumer instructions, more than one counter may be incremented for the more than one consumer instructions for each corresponding producer instruction. Accordingly, any method of tracking may be employed and the exemplary aspects disclosed herein are merely meant to represent some example implementations.

In an example, N×M matrix 250 may be implemented in hardware (or suitable combinations of hardware and software), wherein each of the N×M elements at respective row, column intersections may comprise a counter (e.g., a 64-bit counter). The counter of an element is configured to be incremented each time a producer, consumer instruction relationship corresponding to the row number, column number associated with the element is encountered. For example, if an instruction 1 is a producer in one of the N rows and instruction 3 is a consumer in one of the M columns, then the counter at element at the intersection of the producer-consumer instruction pair, i.e., the counter at element 1, 3 is incremented. In this manner, the number of instances of respective producer-consumer relationships (for any specified time duration or length of code) may be obtained at each element from the respective counter value.

The design, architecture, placement of functional blocks, routing of wires, etc., may be based on the values of these counters. By including design features which may improve performance of one or more of the producer-consumer instruction pairs (e.g., those with the highest associated counter values), the performance of processor 102 may be improved. The information obtained from the count values of the elements of N×M matrix 250, for example, may be used by an architect or designer of processor 102 to improve the design and performance of future generations or implementations of processor 102. Improvements in the design of processor 102 may comprise one or more of placement of functional blocks (e.g., ALU 120, EX 122, CU 124, LSU 126, RF 128), routing of wires on processor 102, or reconfiguring reconfigurable functional blocks to maximize performance of one or more producer instructions and one or more consumer instructions associated with counters having the highest values in N×M matrix 250. Additionally or alternatively, the information from the count values may be used by processor 102 (e.g., in implementations of processor 102 as a reconfigurable circuit, e.g., implemented in FPGA) to reconfigure itself into a different mode or configuration which may be more suitable for the statistical profile of a dynamic instruction stream which generated the count values. Consider, for instance, that if 20% of all LOAD instructions (among the load instructions in the instruction set) produce data which is consumed by ADD instructions, the design of the instruction pipeline for processor 102 may be such that ALU 120 (or even a dedicated adder) may be placed in close proximity to read lines from a data cache (or close to LSU 126), to accelerate such computations.

In some implementations, N×M matrix 250 may be stored or provisioned in processor 102, for example. Correspondingly, the instruction set executable by processor 102 may also include instructions for managing and manipulating data (e.g., counters) in N×M matrix 250. Such instructions may include, for example, instructions for resetting (e.g., initializing to “0”) the values of all counters of all elements of N×M matrix 250; instructions for retrieving data or count values from one or more elements, e.g., by specifying “row number, column number” identifications of the one or more elements; instructions for inserting data or changing count values of one or more elements, e.g., by specifying “row number, column number” identifications of the one or more elements, etc.

It will also be understood that although an N×M matrix 250 is described above, there is no requirement to track between all instructions in a producer role and all instructions in a consumer role. For instance, if some producer-consumer relationships have been determined in advance to not be possible in an instruction set, then those relationships need not be tracked and accordingly costs associated with counters may be avoided, for example, for elements of N×M matrix 250 whose producer-consumer instruction pair relationship is not possible. Similarly, if some instructions have been deemed in advance as not likely to be a producer instruction or not likely to be a consumer instruction, those instruction may be left out altogether from the corresponding rows or columns, respectively, thus also reducing the implementation costs of the matrix.

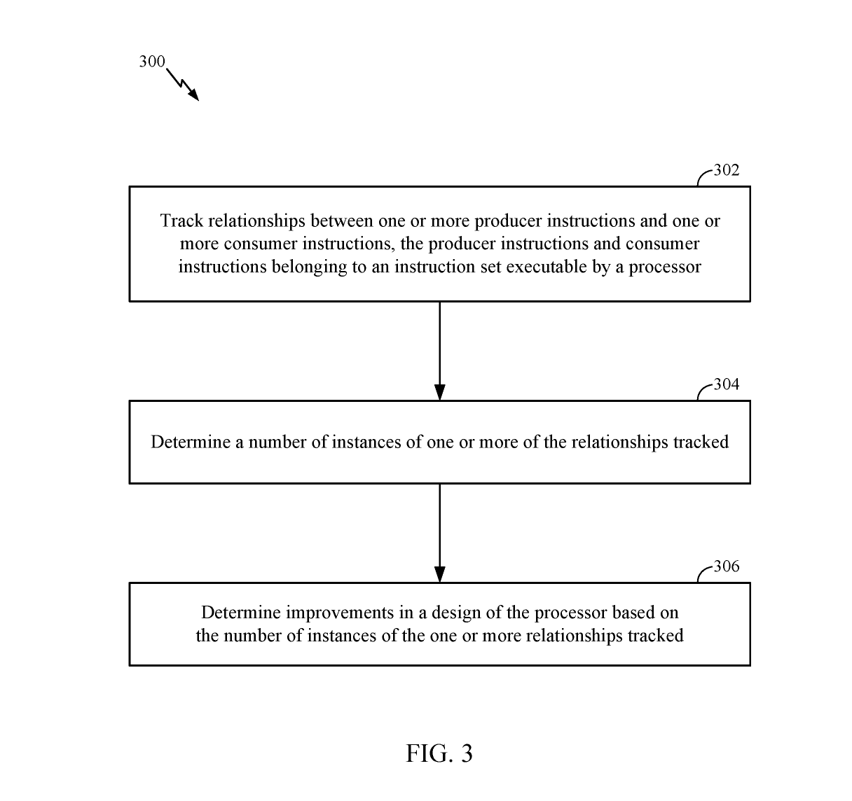

Accordingly, it will be appreciated that exemplary aspects include various methods for performing the processes, functions and/or algorithms disclosed herein. For example, FIG. 3 illustrates a method 300 of modeling a processing system (e.g., processing system 100).

Block 302 comprises tracking relationships between one or more producer instructions and one or more consumer instructions (e.g., in N×M matrix 250), the producer instructions and consumer instructions belonging to an instruction set executable by a processor (e.g., processor 102).

Block 304 comprises determining a number of instances of one or more of the relationships tracked (e.g., using counters at elements of the matrix).

Block 306 comprises determining improvements in a design of the processor based on the number of instances of the one or more relationships tracked (e.g., placing ALU 120 close to LSU 126 to improve the ADD-LOAD producer-consumer instruction pair as discussed above).

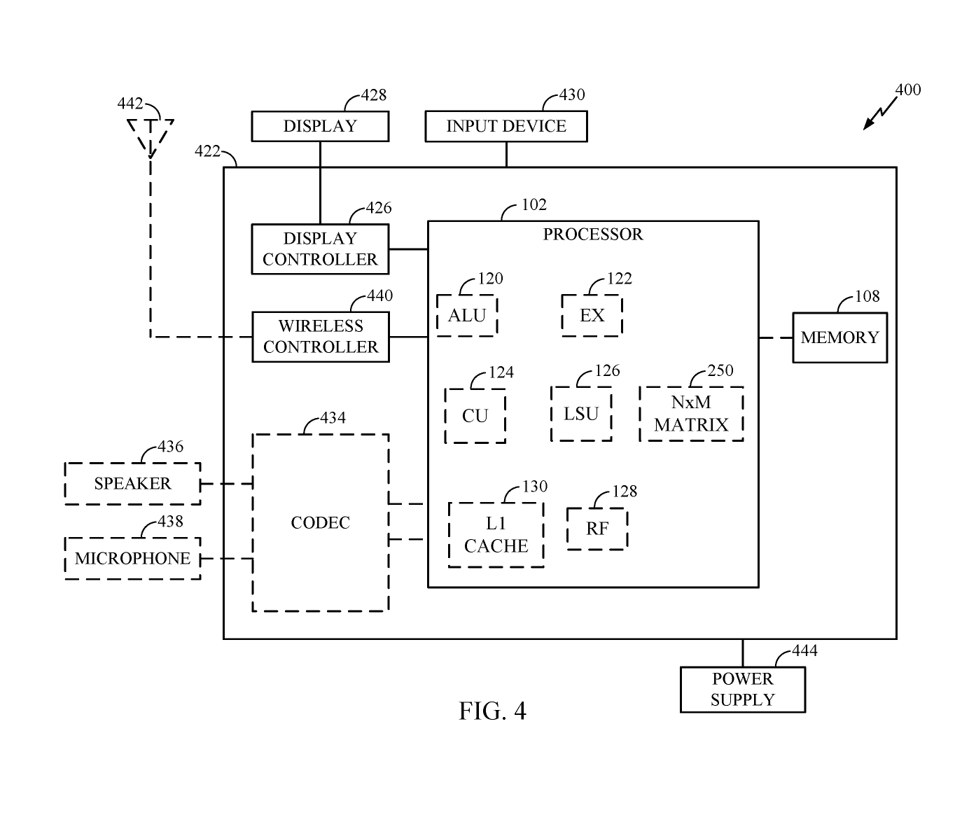

An example apparatus, in which exemplary aspects of this disclosure may be utilized, will now be discussed in relation to FIG. 4. FIG. 4 shows a block diagram of computing device 400. Computing device 400 may correspond to an exemplary implementation of a processing system configured to perform method 300 of FIG. 3. In the depiction of FIG. 4, computing device 400 is shown to include processor 102 and memory 108 of FIG. 1, while other components such as L2 cache 104 and L3 cache 106 have been omitted for the sake of clarity. Components such as ALU 120, EX 122, CU 124, LSU 126, RF 128 and L1 cache 130 have also been illustrated as components of processor 102. In this view, N×M matrix 250 has also been shown as a component of processor 102, although other implementations of this functional block are possible.

FIG. 4 also shows display controller 426 that is coupled to processor 102 and to display 428. In some cases, computing device 400 may be used for wireless communication and FIG. 4 also shows optional blocks in dashed lines, such as coder/decoder (CODEC) 434 (e.g., an audio and/or voice CODEC) coupled to processor 102 and speaker 436 and microphone 438 can be coupled to CODEC 434; and wireless antenna 442 coupled to wireless controller 440 which is coupled to processor 102. Where one or more of these optional blocks are present, in a particular aspect, processor 102, display controller 426, memory 108, and wireless controller 440 are included in a system-in-package or system-on-chip device 422.

Accordingly, in a particular aspect, input device 430 and power supply 444 are coupled to the system-on-chip device 422. Moreover, in a particular aspect, as illustrated in FIG. 4, where one or more optional blocks are present, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 generally depicts a computing device, processor 102 and memory 108, may also be integrated into a set top box, a music player, a video player, an entertainment unit, a navigation device, a personal digital assistant (PDA), a fixed location data unit, a server, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for modeling dataflow in a processing system. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of modeling a processing system, the method comprising:
tracking relationships between one or more producer instructions and one or more consumer instructions, the one or more producer instructions and the one or more consumer instructions belonging to an instruction set executable by a processor;
determining a number of instances of one or more of the relationships tracked; and
determining improvements in a design of the processor based on the number of instances of the one or more relationships tracked.

2. The method of claim 1, comprising tracking the relationships in a matrix, wherein rows of the matrix comprise the one or more producer instructions and columns of the matrix comprise the one or more consumer instructions, and wherein an element of the matrix at an intersection of a row and a column represents a relationship between at least one producer instruction associated with the row and at least one consumer instruction associated with the column.

3. The method of claim 2, wherein the element comprises a counter, and incrementing a counter each time a relationship between the at least one producer instruction and the at least one consumer instruction is encountered during instruction processing by the processor.

4. The method of claim 3, wherein the improvements in the design comprise one or more of placement of functional blocks, routing of wires, or reconfiguring reconfigurable functional blocks to maximize performance of one or more producer instructions and one or more consumer instructions associated with counters having the highest values in the matrix.

5. The method of claim 4, comprising placing a functional block configured to execute the producer instruction in proximity to a functional block configured to execute the consumer instruction to maximize performance of the producer instruction and the consumer instruction.

6. The method of claim 3, further comprising manipulating the matrix with one or more of:
instructions for resetting the values of all counters;
instructions for retrieving data or count values from one or more counters; or
instructions for inserting data or changing count values of one or more counters.

7. An apparatus comprising:
a processor;
logic configured to track relationships between one or more producer instructions and one or more consumer instructions, the one or more producer instructions and the one or more consumer instructions belonging to an instruction set executable by the processor;
logic configured to determine a number of instances of one or more of the relationships tracked; and
logic configured to determine improvements in a design of the processor based on the number of instances of the one or more relationships tracked.

8. The apparatus of claim 7, wherein the logic configured to track relationships comprises a matrix, wherein rows of the matrix comprise the one or more producer instructions and columns of the matrix comprise the one or more consumer instructions, and wherein elements of the matrix at an intersection of a row and a column represents a relationship between at least one producer instruction associated with the row and at least one consumer instruction associated with the column.

9. The apparatus of claim 8, wherein the logic configured to determine the number of instances of one or more of the relationships tracked comprises a counter provided at each element, wherein the counter is configured to be incremented each time a relationship between the at least one producer instruction and the at least one consumer instruction is encountered during instruction processing by the processor.

10. The apparatus of claim 9, wherein the improvements in the design comprise one or more of placement of functional blocks, routing of wires, or reconfiguring reconfigurable functional blocks to maximize performance of one or more producer instructions and one or more consumer instructions associated with counters having the highest values in the matrix.

11. The apparatus of claim 10, wherein the improvements in the design comprises placement of a functional block configured to execute the producer instruction in proximity to a functional block configured to execute the consumer instruction to maximize performance of the producer instruction and the consumer instruction.

12. The apparatus of claim 9, wherein the logic configured to track the relationships is further configured to, based on one or more instructions:
reset the values of all counters;
retrieve data or count values from one or more counters; or
insert data or changing count values of one or more counters.

13. The apparatus of claim 7, integrated into a device consisting of a set top box, a music player, a video player, an entertainment unit, a navigation device, a personal digital assistant (PDA), a fixed location data unit, a server, a computer, a laptop, a tablet, a communications device, and a mobile phone.

14. A non-transitory computer-readable storage medium comprising code, which, when executed by a computer, causes the computer to perform operations for modeling a processor, the non-transitory computer-readable storage medium comprising:
code for tracking relationships between one or more producer instructions and one or more consumer instructions, the one or more producer instructions and the one or more consumer instructions belonging to an instruction set executable by the processor;
code for determining a number of instances of one or more of the relationships tracked; and
code for determining improvements in a design of the processor based on the number of instances of the one or more relationships tracked.

15. The non-transitory computer-readable storage medium of claim 14, comprising code for tracking the relationships in a matrix, wherein rows of the matrix comprise the one or more producer instructions and columns of the matrix comprise the one or more consumer instructions, and wherein elements of the matrix at an intersection of a row and a column represents a relationship between at least one producer instruction associated with the row and at least one consumer instruction associated with the column.

16. The non-transitory computer-readable storage medium of claim 15, further comprising code for incrementing a counter disposed at an element of the matrix each time a relationship between the at least one producer instruction and the at least one consumer instruction corresponding to the element is encountered during instruction processing by the processor.

17. The non-transitory computer-readable storage medium of claim 16, wherein the improvements in the design comprise one or more of placement of functional blocks, routing of wires, or reconfiguring reconfigurable functional blocks to maximize performance of one or more producer instructions and one or more consumer instructions associated with counters having the highest values in the matrix.

18. The non-transitory computer-readable storage medium of claim 17, comprising code for placing a functional block configured to execute the producer instruction in proximity to a functional block configured to execute the consumer instruction to maximize performance of the producer instruction and the consumer instruction.

19. The non-transitory computer-readable storage medium of claim 17, further comprising:
instructions for resetting the values of all counters at the elements of the matrix;
instructions for retrieving data or count values from one or more counters; or
instructions for inserting data or changing count values of one or more counters.

20. An apparatus comprising:
means for processing;
means for tracking relationships between one or more producer instructions and one or more consumer instructions, the one or more producer instructions and the one or more consumer instructions belonging to an instruction set executable by the means for processing;
means for determining a number of instances of one or more of the relationships tracked; and
means for determining improvements in a design of the means for processing based on the number of instances of the one or more relationships tracked.

21. The apparatus of claim 20, wherein the improvements in the design comprise one or more of placement of functional blocks, routing of wires, or reconfiguring reconfigurable functional blocks to maximize performance of one or more producer instructions and one or more consumer instructions associated with counters having the highest values in the means for tracking relationships.

22. The apparatus of claim 21, comprising means for placing a functional block configured to execute the producer instruction in proximity to a functional block configured to execute the consumer instruction to maximize performance of the producer instruction and the consumer instruction.
